(19) United States
(12) Patent Application Publication
(10) Pub. No.: US 2015/0149204 A1
(43) Pub. Date: May 28, 2015

(54) METHOD AND SYSTEM FOR INTEGRATING MEDICAL DATA WITH TRANSACTION DATA WHILE MAINTAINING CONSUMER PRIVACY

(71) Applicant: MasterCard International Incorporated, Purchase, NY (US)

(72) Inventors: Kenny UNSER, Fairfield, CT (US); Serge BERNARD, Danbury, CT (US); Nikhil MALGATTI, Stamford, CT (US)

(73) Assignee: MasterCard International Incorporated, Purchase, NY (US)

(21) Appl. No.: 14/088,174

(22) Filed: Nov. 22, 2013

(51) Int. Cl. G06Q 30/02; G06Q 50/22; G06Q 40/00

(52) U.S. Cl. CPC G06Q 30/0204; G06Q 40/12; G06Q 50/22
USPC 705/3

(57) ABSTRACT

A method for linking medical data to transaction history includes: storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a medical profile, wherein the medical profile includes medical data associated with a specific consumer and a plurality of demographic characteristics associated with the specific consumer; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the medical data included in the received medical profile.

### FIELD

The present disclosure relates to the linking of medical data to transaction history, specifically the linking of consumer medical information with consumer transaction history based on a plurality of demographic characteristics while maintaining consumer privacy.

### BACKGROUND

Merchants, retailers, offer providers, advertisers, and other entities that distribute offers, deals, advertisements, and other content to consumers may often times attempt to target specific consumers for content distribution. Targeting specific consumers may result in both lower resource costs for creating and distributing content and higher returns generated from the consumers. In order to further increase the rate of return that merchants and other entities get from consumers, these entities often try to gather as much detail about consumers as possible. One such type of data may include transaction data. Transaction data may be valuable for merchants and other entities as the history of transactions for a consumer may indicate consumer preferences or predict future behaviors, and thus be used to identify consumers who may be more receptive to a particular offer or advertisement.

However, transaction data alone may sometimes be ineffective for use in targeting consumers. Identifying consumers based on past transactions may be a reactive process, rather than a proactive process. For example, a consumer may not be targeted for the purchase of a particular product until after the product or a similar product is already purchased. As a result, the consumer may no longer be influenced with regards to the purchase, which may be particularly troublesome with respect to products that are not purchased often, such as televisions, automobiles, computers, mobile phones, etc. Thus, merchants and other entities may desire additional information regarding a consumer, especially information that may be used to predict future behaviors.

Medical data may be used to provide for predictions of future behaviors and may be useful for merchants, offer providers, and others to target consumers for the distribution of content. However, many consumers may be unwilling to provide consent for their medical data to be made available. In addition, for medical data that may be available, many entities may be unable to link a consumer's medical data to a consumer's transaction history without additional cooperation from the consumer. This may result in a significant time and resource commitment of the consumer, which may discourage the consumer from participating.

Thus, there is a need for a technical solution to provide linkage between transaction data and medical data while maintaining a high level of consumer privacy and security through the use of consumer association and microsegmentation.

### SUMMARY

The present disclosure provides a description of systems and methods for linking medical data to transaction history and distributing consumer profiles.

A method for linking medical data to transaction history includes: storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a medical profile, wherein the medical profile includes medical data associated with a specific consumer and a plurality of demographic characteristics associated with the specific consumer; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the medical data included in the received medical profile.

A method for distributing a linked consumer profile includes: storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer; receiving, by a receiving device, a consumer profile request, wherein the consumer profile request includes at least a specific consumer identifier; identifying, in the database, a specific consumer profile where the included consumer identifier corresponds to the specific consumer identifier; transmitting, by a transmitting device, a request for medical data, wherein the request for medical data includes at least the plurality of consumer characteristics included in the identified specific consumer profile; receiving, by the receiving device, medical data; including, in the database, the received medical data in the identified specific consumer profile; and transmitting, by the transmitting device, the specific consumer profile including the received medical data in response to the received consumer profile request.

Another method for linking medical data to transaction history includes: storing, in a database, a plurality of consumer profiles, wherein each consumer profile includes data related to a consumer including at least a consumer identifier and a plurality of transaction data entries, each transaction data entry corresponding to a payment transaction involving the related consumer; receiving, by a receiving device, a medical profile, wherein the medical profile includes medical data associated with a specific consumer including at least a specific consumer identifier and data included in an electronic health record corresponding to the specific consumer; identifying, by a processing device, a specific consumer profile of the plurality of consumer profiles where the included consumer identifier corresponds to the specific consumer identifier; and associating, in the database, the identified specific consumer profile with the medical data included in the received medical profile.

A system for linking medical data to transaction history includes a database, a receiving device, and a processing device. The database is configured to store a plurality of consumer profiles, wherein each consumer profile includes data related to a consumer including at least a plurality of consumer characteristics and a plurality of transaction data entries, each transaction data entry corresponding to a payment transaction involving the related consumer. The receiving device is configured to receive a medical profile, wherein the medical profile includes medical data associated with a specific consumer and a plurality of demographic characteristics associated with the specific consumer. The processing device is configured to: identify at least one consumer profile of the plurality of consumer profiles where at least a predefined number of the included plurality of consumer characteristics correspond to the plurality of demographic characteristics; and associate, in the database, each of the identified at least one consumer profile with the medical data included in the received medical profile.

A system for distributing a linked consumer profile includes a database, a receiving device, a processing device, and a receiving device. The database is configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer. The receiving device is configured to receive a consumer profile request, wherein the consumer profile request includes at least a specific consumer identifier. The processing device is configured to identify, in the database, a specific consumer profile where the included consumer identifier corresponds to the specific consumer identifier. The transmitting device is configured to transmit a request for medical data, wherein the request for medical data includes at least the plurality of consumer characteristics included in the identified specific consumer profile. The receiving device is further configured to receive medical data. The processing device is further configured to include, in the database, the received medical data in the identified specific consumer profile. The transmitting device is further configured to transmit the specific consumer profile including the received medical data in response to the received consumer profile request.

Another system for linking medical data to transaction history includes a database, a receiving device, and a processing device. The database is configured to store a plurality of consumer profiles, wherein each consumer profile includes data related to a consumer including at least a consumer identifier and a plurality of transaction data entries, each transaction data entry corresponding to a payment transaction involving the related consumer. The receiving device is configured to receive a medical profile, wherein the medical profile includes medical data associated with a specific consumer including at least a specific consumer identifier and data included in an electronic health record corresponding to the specific consumer. The processing device is configured to: identify a specific consumer profile of the plurality of consumer profiles where the included consumer identifier corresponds to the specific consumer identifier; and associate, in the database, the identified specific consumer profile with the medical data included in the received medical profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for linking consumer medical data and transaction history while maintaining consumer privacy in accordance with exemplary embodiments.

FIG. 2 is a block diagram illustrating the processing server of FIG. 1 for the linking of consumer medical data and transaction history while maintaining consumer privacy in accordance with exemplary embodiments.

FIG. 3 is a flow diagram illustrating a method for linking medical data with transaction history in a consumer profile in accordance with exemplary embodiments.

FIG. 4 is a flow chart illustrating a method for populating and distributing a consumer profile including medical data and transaction history in accordance with exemplary embodiments.

FIG. 5 is a diagram illustrating the linking of consumer medical data to transaction history while maintaining consumer privacy in accordance with exemplary embodiments.

FIGS. 6A and 6B are a flow diagram illustrating a method for distributing content to a consumer based on private linked medical and transaction data in accordance with exemplary embodiments.

FIG. 7 is a flow chart illustrating an exemplary method for linking medical data to transaction history in accordance with exemplary embodiments.

FIG. 8 is a flow chart illustrating an exemplary method for distributing a linked consumer profile in accordance with exemplary embodiments.

FIG. 9 is a flow chart illustrating an exemplary method for linking a consumer medical profile to transaction history in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems that do not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the systems and methods discussed herein may not possess the PII or be able to decrypt the encrypted PII.

Microsegment—A representation of a group of consumers that is granular enough to be valuable to advertisers, marketers, offer providers, merchants, retailers, etc., but still maintain a high level of consumer privacy without the use or obtaining of personally identifiable information. Microsegments may be given a minimum or a maximum size. A minimum size of a microsegment would be at a minimum large enough so that no entity could be personally identifiable, but small enough to provide the granularity needed in a particular circumstance. Microsegments may be defined based on geographical or demographical information, such as age, gender, income, marital status, postal code, income, spending propensity, familial status, etc., behavioral variables, or any other suitable type of data, such as discussed herein. The granularity of a microsegment may be such that behaviors or data attributed to members of a microsegment may be similarly attributable or otherwise applied to consumers having similar characteristics. In some instances, microsegments may be grouped into an audience. An audience may be any grouping of microsegments, such as microsegments having a common data value, microsegments encompassing a plurality of predefined data values, etc. In some instances, the size of a microsegment may be dependent on the application. An audience based on a plurality of microsegments, for instance, might have ten thousand entities, but the microsegments would be aggregated when forming the audience and would not be discernible to anyone having access to an audience. Additional detail regarding microsegments and audiences may be found in U.S. patent application Ser. No. 13/437,987, entitled “Protecting Privacy in Audience Creation,” by Curtis Villars et al., filed on Apr. 3, 2012, which is herein incorporated by reference in its entirety.

### System for Linking Medical Data to Transaction History

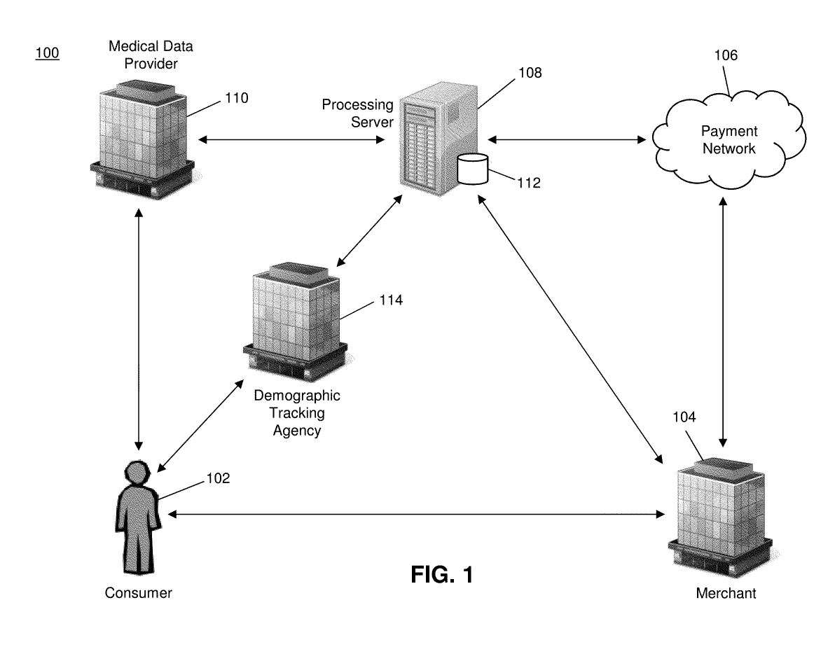

FIG. 1 illustrates a system 100 for linking consumer medical data to consumer transaction history while maintaining consumer privacy.

A consumer 102 may engage in one or more payment transactions at a merchant 104. The payment transaction or transactions may be conducted in person (e.g., at a physical location of the merchant 104), or remotely, such as via the Internet, telephone, by mail, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 112, also discussed in more detail below, associated with the consumer 102. In an exemplary embodiment, the transaction data may only be stored in a consumer profile associated with the particular consumer 102 with the permission of the consumer 102.

The processing server 108 may also receive demographic characteristics associated with the consumer 102 from a demographic tracking agency 114 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics, such as in a microsegment.

The system 100 may also include a medical data provider 110. The medical data provider 110 may be an entity configured to receive and store medical and demographic data regarding the consumer 102, such as hospital or health network, an insurance provider, etc. In some instances, the medical data provider 110 may obtain medical data corresponding to the consumer 102 with the consent of the consumer 102. In other instances, the medical data may be anonymous or otherwise not personally identifiable to the consumer 102. For example, the medical data may be associated with consumer demographic characteristics that are not personally identifiable, as discussed in more detail below. The medical data may include data included in an electronic health record, data provided by an associated consumer, or other data as will be apparent to persons having skill in the relevant art.

The medical data provider 110 may be configured to furnish the stored medical data and corresponding consumer characteristics to the processing server 108, which may then store the data in corresponding consumer profiles in the consumer database 112. The processing server 108 may match the medical data to one or more consumer profiles based on the demographic characteristics and the consumer characteristics of the one or more consumer profiles. In such an instance, the medical data may be associated with transaction data without the identification of a specific consumer 102 and without including any personally identifiable information. By linking the medical data to the transaction history via demographic characteristics, an accurate linkage may be established while simultaneously maintaining a high level of consumer privacy.

In some embodiments, the processing server 108 may transmit demographic characteristics for one or more consumer profiles to the medical data provider 110. The medical data provider 110 may then identify medical data corresponding to the consumer characteristics, and distribute the identified medical data to the processing server 108. The processing server 108 may then store the medical data in the corresponding one or more consumer profiles. Methods for identifying correspondence between demographic characteristics and consumer characteristics are discussed in more detail below. Additional methods for obtaining the medical data for one or more consumers without personally identifying a consumer will be apparent to persons having skill in the relevant art.

The processing server 108 may then have transaction history and medical data for a consumer 102 linked together in a consumer profile associated with the consumer 102. In an exemplary embodiment, the consumer profile may not include any personally identifiable information for the consumer 102, except with the express consent of the consumer 102. In other embodiments, a consumer profile may be associated with the consumer 102 solely based on demographic characteristics. As such, the consumer profile may not include medical data associated specifically with the consumer 102, as the medical data may be associated with a different consumer sharing the same or similar consumer characteristics or a generic consumer of the same or similar consumer characteristics.

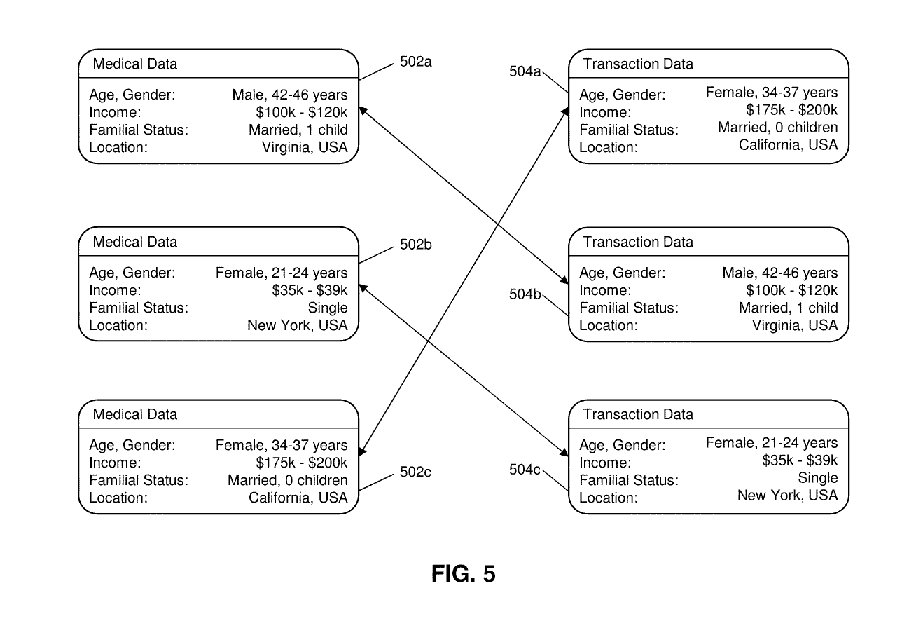

In some instances, a consumer profile may be associated with a microsegment of consumers including the consumer 102. For example, a consumer profile may be associated with ten or more consumers having the same or similar consumer characteristics, as illustrated in FIG. 5 and discussed in more detail below, and thus may include medical data not personally identifiable of any consumer in the microsegment. The medical data included in such a consumer profile may thus be medical data associated any consumer associated the consumer characteristics included in the consumer profile, which may be any of, or none of, the consumers 102 associated with the consumer profile. As a result, the medical data may be linked to transaction history of one or more of the consumers, and thus associated with the consumer 102, while maintaining a very high level of consumer privacy.

The use of microsegments and association of consumers to other consumers or a generic consumer based on consumer characteristics may thus result in a high accuracy of linked medical and transaction data, without violating a consumer's privacy. In addition, by linking transaction history with medical data, the processing server 108, or a third party, such as an advertiser, that may receive the data from the processing server 108, may be able to obtain significantly more data from a consumer's combined medical and transaction history than utilizing either set of data alone.

### Processing Server

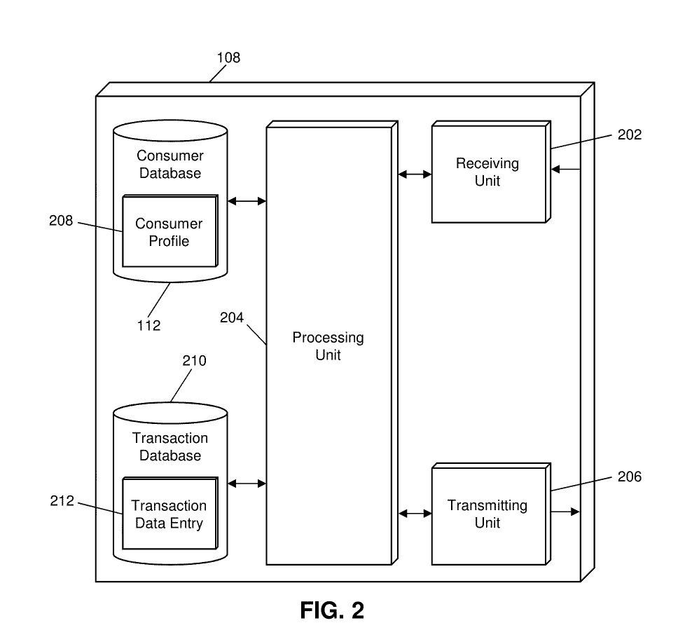

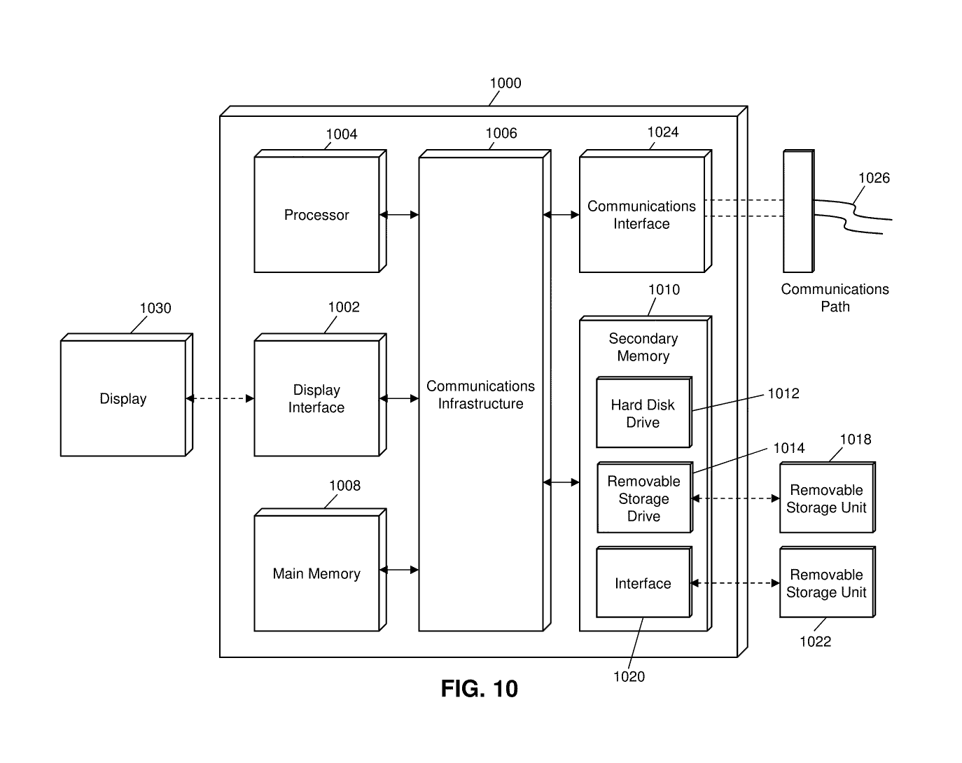

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 1000 illustrated in FIG. 10 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data, demographic characteristic data, and medical data. The receiving unit 202 may also be configured to receive consumer profile or data requests, such as from the merchant 104 or other third party.

The processing server 108 may also include a processing unit 204. The processing unit 204 may be configured to store received transaction data in a transaction database 210 as one or more transaction data entries 212. Each transaction data entry 212 may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiment, each transaction data entry may also include demographic characteristics for a consumer (e.g., consumer characteristics) involved in the corresponding payment transaction.

The processing unit 204 may also be configured to store a plurality of consumer profiles 208 in the consumer database 112. Each consumer profile 208 may include data related to a consumer (e.g., the consumer 102), including at least a plurality of consumer characteristics. In some embodiments, each consumer profile 208 may also include a plurality of transaction data entries 212. In an exemplary embodiment, each consumer profile 208 may not include personally identifiable information unless expressly consented to by the corresponding consumer 102. In some embodiments, each consumer profile 208 may be associated with a specific set of consumer characteristics and may accordingly be related to a generic consumer of those characteristics rather than an actual consumer 102. In other embodiments, each consumer profile 208 may be associated with a specific set or range of consumer characteristics and associated with a plurality of (e.g., a microsegment of) consumers 102.

The processing unit 204 may be configured to link consumer profiles 208 with transaction data entries 212 based on demographic characteristics. The processing unit 204 may also be configured to link consumer profiles 208 including transaction data entries 212 with medical data received by the receiving unit 202. The processing unit 204 may be configured to link the consumer profiles 208 with the medical data via demographic characteristics included in the consumer profiles 208 and in the received medical data. In some instances, the processing unit 204 may match medical data to transaction history based on a predefined number of demographic characteristics (e.g., at least the predefined number of characteristics must match). In other instances, transaction history and medical data may be matched via algorithms or other systems and methods that will be apparent to persons having skill in the relevant art. In some embodiments, the processing unit 204 may store the received medical data in the linked consumer profile 208.

The processing server 108 may also include a transmitting unit 206. The transmitting unit 206 may be configured to transmit data over one or more networks via one or more network protocols. The transmitting unit 206 may be configured to transmit requests for data, such as to the medical data provider 110 or a demographic tracking agency 114. The transmitting unit 206 may also be configured to transmit transaction history and/or medical data, or a consumer profile 208 including linked transaction history and medical data, in response to a request from a third party (e.g., an advertiser). In some instances, the processing unit 204 may be configured to modify, scrub, or remove data included in the consumer profile 208 prior to transmission to a third party, such as to maintain consumer privacy.

### Method for Linking Medical Data to Transaction History

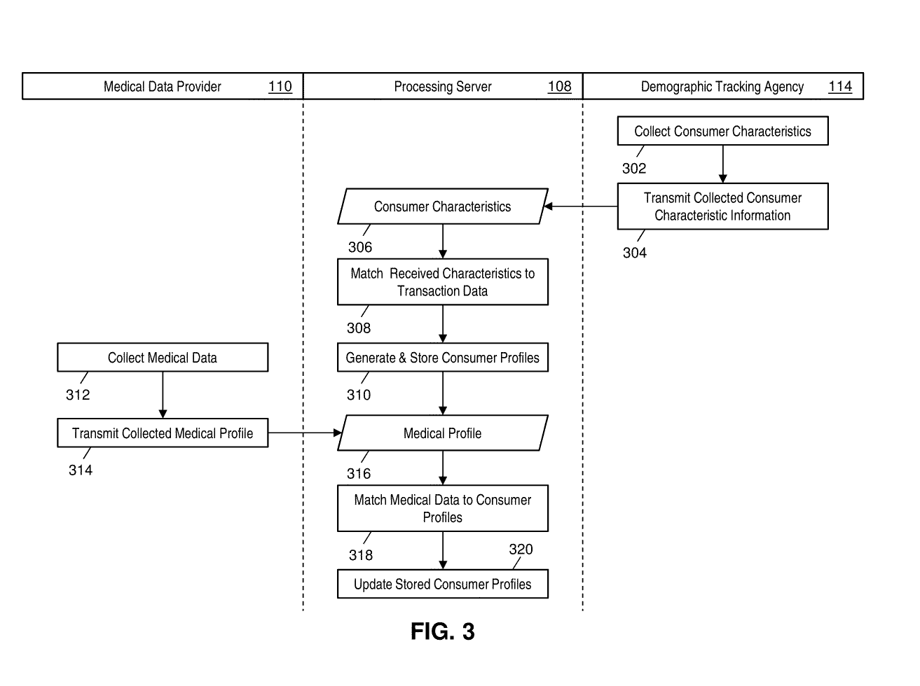

FIG. 3 illustrates a method for linking consumer medical data to transaction history.

In step 302, the demographic tracking agency 114 may collect demographic characteristics for one or more consumers. Methods and systems for collecting demographic characteristics will be apparent to persons having skill in the relevant art. The demographic tracking agency 114 may collect the information and may, in step 304, transmit the collected demographic characteristic information to the processing server 108.

In step 306, the processing server 108 may receive the demographic characteristic information. In step 308, the processing unit 204 of the processing server 108 may match the received demographic characteristic information to transaction data entries 212 included in the transaction database 210. In step 310, the processing unit 204 may generate consumer profiles 208 for matched transaction history and demographic characteristics (e.g., consumer characteristics) and store the consumer profiles 208 in the consumer database 112. In an exemplary embodiment, the processing unit 204 may bucket or otherwise modify the consumer characteristic information and/or transaction data to render the corresponding consumer profile 208 not personally identifiable. In some instances, the processing unit 204 may group transaction data entries 212 for multiple consumers sharing consumer characteristics into a single consumer profile 208.

In step 312, the medical data provider 110 may store medical profiles for one or more consumers 102, the medical profiles including medical data and a plurality of demographic characteristics that are associated with the corresponding one or more consumers 102. In step 314, the medical data provider 110 may transmit the collected medical profile to the processing server 108. The processing server 108 may, in step 316, receive the medical profile from the medical data provider 110.

In step 318, the processing unit 204 of the processing server 108 may match the received medical data to the consumer profiles 208 based on matching of the demographic and consumer characteristics. In embodiments where the consumer 102 associated with the medical data may consent to the use of the medical data, the processing unit 204 may match the medical data to a consumer profile 208 using a consumer identifier, such as a payment account number, phone number, e-mail address, street address, etc. In step 320, the processing unit 204 may update the consumer profiles 208 to include and/or be associated with the matched medical data.

### Method for Distributing a Consumer Profile

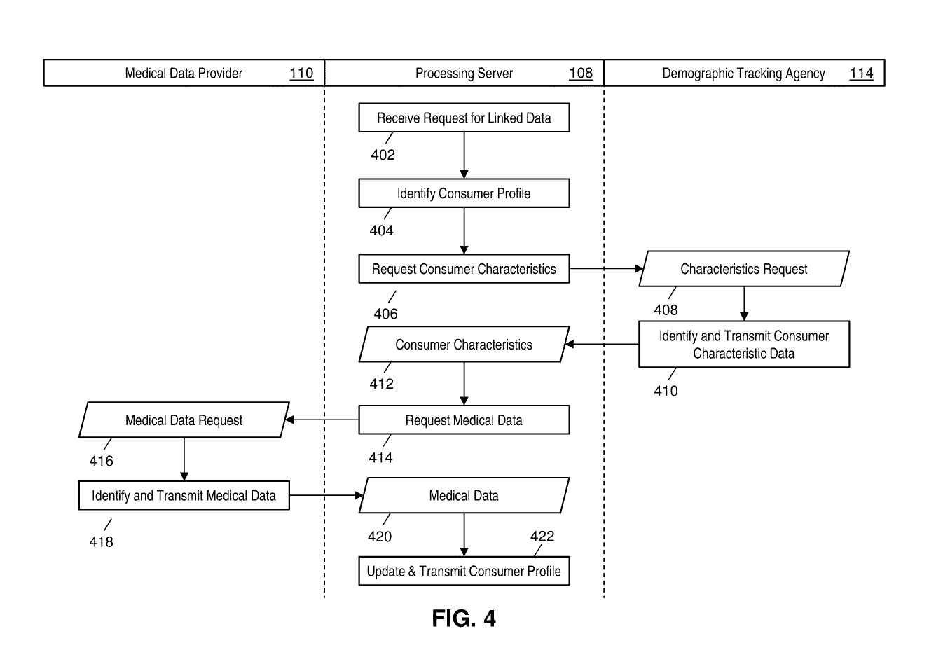

FIG. 4 illustrates a method for distributing a consumer profile including linked medical data and transaction history.

In step 402, the processing server 108 may receive (e.g., via the receiving unit 202) a request for linked consumer medical and transaction data. The request for linked data may include a consumer identifier or other identifying information, such as consumer characteristics. In step 404, the processing unit 204 may identify, in the consumer database 112, a consumer profile 208 based on the information included in the request.

In step 406, the processing server 108 may transmit (e.g., via the transmitting unit 206), a request to the demographic tracking agency 114 for consumer characteristics for the consumer associated with the identified consumer profile 208. In step 408, the demographic tracking agency 114 may receive the request, and, in step 410, may identify consumer characteristics associated with the consumer and transmit them back to the processing server 108. In step 412, the processing server 108 may receive the consumer characteristics associated with the consumer 102 related to the identified consumer profile 208.

In step 414, the processing server 108 may request medical data for the consumer 102 from the medical data provider 110. The medical data request may include the previously received consumer characteristics. In embodiments where the consumer 102 may consent to the obtaining of medical data associated with the consumer 102, the medical data request may include information identifying the consumer 102. In step 416, the medical data provider 110 may receive the medical data request, and, in step 418, identify medical data associated with the consumer characteristics received in the medical data request. The medical data provider 110 may transmit the medical data to the processing server 108, which may receive the medical data in step 420.

In step 422, the processing server 108 may update the consumer profile 208 to include the received medical data, and may transmit the consumer profile 208 and/or the included transaction history and medical data as a response to the initially received request. In an exemplary embodiment, the consumer profile 208 may not include any personally identifiable information for the related consumer 102. In other embodiments, the processing server 108 may remove and/or render personally unidentifiable any personally identifiable information included in the consumer profile 208.

### Linking Medical Data to Transaction History

FIG. 5 illustrates the linking of consumer medical data 502 to transaction history 504 using demographic characteristics.

Each set of medical data 502, illustrated in FIG. 5 as medical data 502a, 502b, and 502c, may correspond to a consumer 102 and include a plurality of demographic characteristics. For example, medical data 502a corresponds to a consumer 102 that is a male, of an age between 42 and 46 years old, has an income between $100,000 and $120,000, is married, has one child, and lives in Virginia. In some embodiments, the medical data 502a may correspond to a plurality of consumers each having the same demographic characteristics data, such as a microsegment of consumers. As illustrated in FIG. 5, the medical data 502 may not include any personally identifiable information, as the associated demographic characteristics may correspond to a plurality of consumers 102. At the same time, the demographic characteristics may enable accurate linkage of the medical data 502 to transaction data 504 due to the specificity of the characteristics while maintaining the privacy of associated consumers.

Each set of transaction data 504, illustrated in FIG. 5 as transaction data 504a, 504b, and 504c, may correspond to a consumer 102 or a plurality of consumers 102, and include a plurality of consumer characteristics associated with the corresponding consumer or consumers 102. For example, transaction data 504a may correspond to a consumer 102 that is a female, of an age between 34 and 37 years old, has an income between $175,000 and $200,000, is married, has no children, and lives in California.

The processing unit 204 of the processing server 108 may identify the demographic characteristics for each of the medical data 502 and transaction data 504 and match the two sets of data based on common demographic and consumer characteristics. For example, in the example illustrated in FIG. 5, the processing unit 204 may match medical data 502a with transaction data 504b, medical data 502b with transaction data 504c, and medical data 502c with transaction data 504a. The processing unit 204 may then store the linked data in one or more consumer profiles 208 including the corresponding consumer characteristics.

In some embodiments, the demographic characteristics for the medical data 502 may not directly correspond to the consumer characteristics for the transaction data 504. In such an instance, the processing unit 204 may be configured to link the data based on a predefined number of matching characteristics. For example, if the transaction data 504b was associated with a consumer 102 having two children (instead of the one child illustrated in FIG. 5), while the medical data 502a is associated with a consumer 102 having only one child, the processing unit 204 may still link the two sets of data because the sets have at least five matching demographic characteristics including age, gender, income, marital status, and geographic location. Such associations may protect the privacy of the consumers while still utilizing accurate medical and transaction data.

### Application of Linked Profiles for Content Distribution

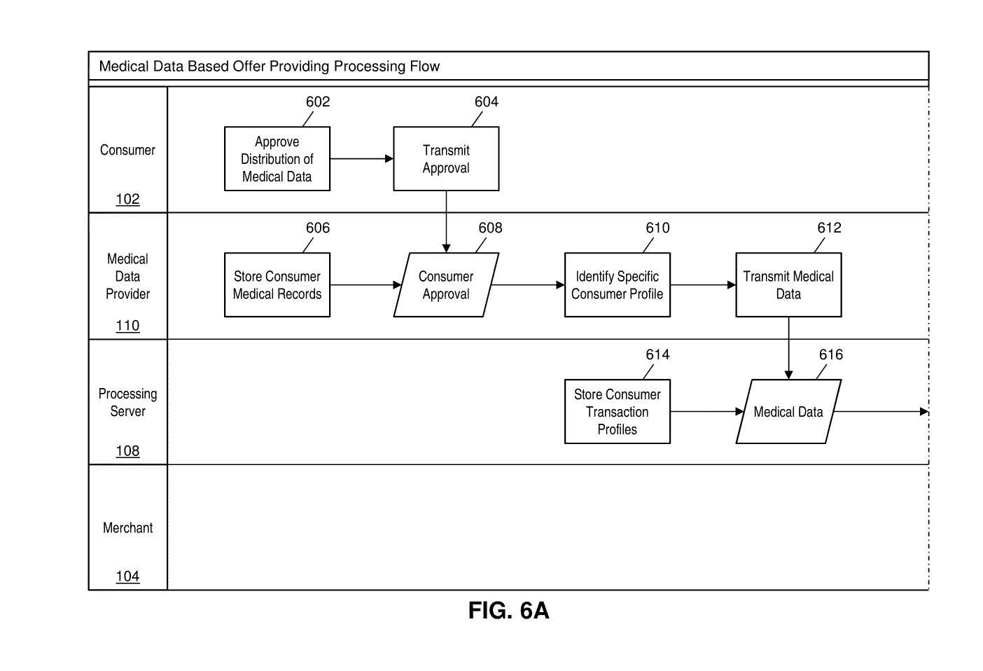

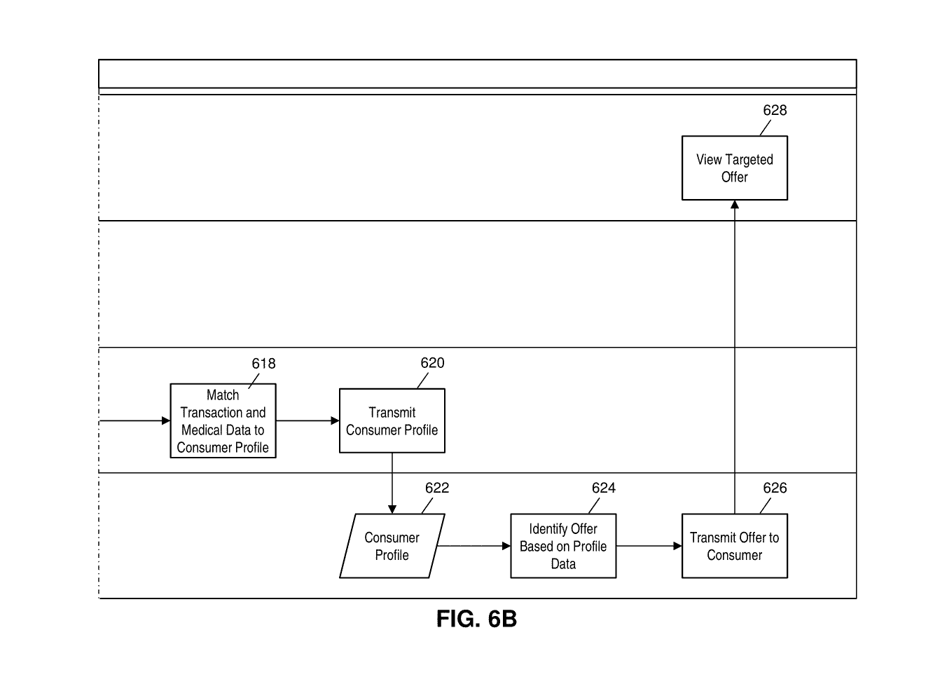

FIGS. 6A and 6B illustrate a method for the distribution of content to a consumer 102 based on a linked consumer profile including transaction history and medical data generated and/or distributed using the methods and systems as discussed herein. It will be apparent to persons having skill in the relevant art that the distribution of content based on a linked consumer profile is used as an illustration of a potential application of the systems and methods discussed herein only, and that there may be a variety of additional applications of linked transaction and medical data.

In step 602, the consumer 102 may provide approve the distribution of medical data associated with the consumer 102, such as by signing a release form or performing another suitable action. In step 604, the consumer 102 may transmit the approval of release of medical data to the medical data provider 110. In step 606, the medical data provider 110 may store a medical profile for one or more consumers 102. The medical profile may include medical data for each respective consumer 102 and may further include a plurality of demographic characteristics associated with the respective consumer 102. In step 608, the medical data provider 110 may receive the approval of the consumer for the release of medical data.

In step 610, the medical data provider 110 may identify the consumer medical profile corresponding to the consumer 102 based on the supplied approval. In instances where a consumer 102 may desire increased privacy, the medical data provider 110 may identify a consumer medical profile based on demographic characteristics (e.g., associated with the consumer 102 or as requested by the processing server 108) that is not directly associated with the consumer 102. For example, the identified medical profile may be associated with a generic consumer similar to the consumer 102, a similar consumer, or a microsegment of consumers including the consumer 102.

In step 612, the medical data provider 110 may transmit the medical data and plurality of demographic characteristics included in the consumer medical profile to the processing server 108. In step 614, the processing server 108 may store a plurality of consumer profiles 208 associated with consumers 102 including transaction data entries corresponding to payment transactions involving the respective consumers 102 and consumer characteristics associated with the respective consumers 102. In step 616, the processing server 108 may receive the plurality of demographic characteristics and medical data from the medical data provider 110.

In step 618, the processing server 108 may match the received medical data and the stored consumer transaction profile to one or more consumer profiles 208 based on a correspondence between the received demographic characteristics and the consumer characteristics included in each of the respective one or more consumer profiles 208. In some instances, the received medical profile may be associated with consumer profiles 208 associated with multiple consumers 102, such as if consumers 102 are grouped together to protect consumer privacy and security.

In step 620, the processing server 108 may transmit the linked consumer profile to the merchant 104. It will be apparent to persons having skill in the relevant art that, in the embodiment illustrated in FIGS. 6A and 6B, the merchant 104 may be replaced by an offer provider, content provider, or other suitable entity. In step 622, the merchant 104 may receive the linked consumer profile. In some embodiments, the processing server 108 may transmit only requested information and/or information that has been indicated as acceptable for distribution by the consumer 102 and/or the medical data provider 110. In some instances, the processing server 108 may remove any personally identifiable information from the consumer profile 208 prior to transmitting.

In some embodiments, the merchant 104 may first submit a request for a consumer profile to the processing server 108, which may include medical data requested by the merchant 104. The processing server 108 may subsequently identify the linked consumer profile including the medical data, and then transmit the specific medical data requested by the merchant 104 to the merchant 104 in step 620.

In step 624, the merchant 104 may identify an offer or other targeted content based on the profile data, including the characteristics, transaction history, and medical data. In step 626, the merchant 104 may transmit the identified offer or content to the consumer 102 using methods and systems that will be apparent to persons having skill in the relevant art. In step 628, the consumer 102 may receive and view the targeted offer or content.

The use of medical and transaction data to target content may be highly beneficial for merchants and other entities. For example, a manufacturer of products for diabetics may be able to target consumers that are diabetic. In instances where medical data may be obtained that may not be related to a specific consumer 102, but may be related to a similar consumer or a microsegment of consumers including the consumer 102, content providers may still use the medical data to identify content for distribution to the consumer 102. For example, other consumers having similar medical history or demographics may exhibit particular purchasing trends, which may be used to identify products for advertising to the consumer 102. In such an instance, the consumer 102 may be accurately targeted while the security and privacy of the consumer 102 is still maintained.

### Exemplary Method for Linking Medical Data to Transaction History

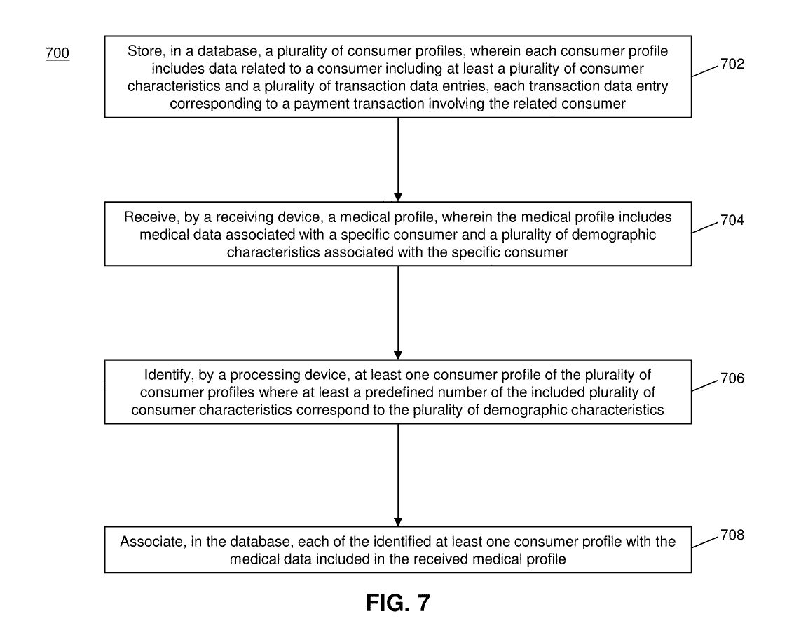

FIG. 7 illustrates a method 700 for linking consumer medical data to transaction history using demographic characteristics.

In step 702, a plurality of consumer profiles (e.g., the consumer profiles 208) may be stored in a database (e.g., the consumer database 112), wherein each consumer profile 208 includes data related to a consumer (e.g., the consumer 102) including at least a plurality of consumer characteristics and a plurality of transaction data entries (e.g., transaction data entries 212), each transaction data entry 212 corresponding to a payment transaction involving the related consumer 102. In some embodiments, the plurality of consumer characteristics may not be personally identifiable.

In one embodiment, the plurality of consumer characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 704, a medical profile may be received, by a receiving device (e.g., the receiving unit 202), wherein the medical profile includes medical data associated with a specific consumer 102 and a plurality of demographic characteristics associated with the specific consumer. In one embodiment, the medical data may be included in an electronic health record corresponding to the associated specific consumer 102. In some embodiments, the plurality of demographic characteristics may not be personally identifiable. In one embodiment, the medical profile may be obtained with the express consent of the associated specific consumer 102.

In step 706, at least one consumer profile 208 of the plurality of consumer profiles may be identified, by a processing device (e.g., the processing unit 204), where at least a predefined number of the included plurality of consumer characteristics correspond to the plurality of demographic characteristics. In step 708, each of the identified at least one consumer profiles 208 may be associated, in the consumer database 112, with the medical data included in the received medical profile.

### Exemplary Method for Distributing a Linked Consumer Profile

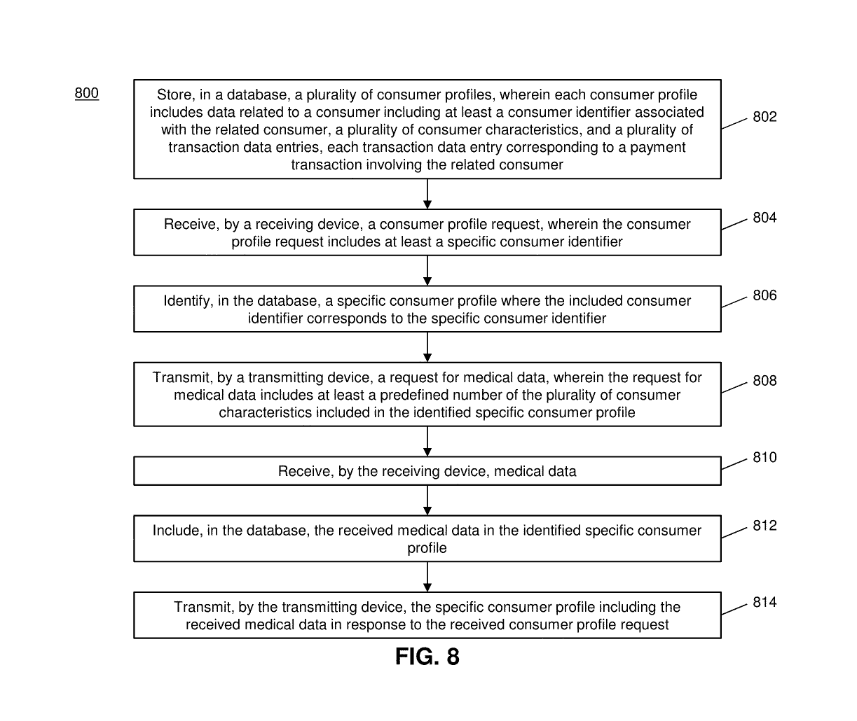

FIG. 8 illustrates a method 800 for distributing a consumer profile including medical data and transaction history linked based on demographic characteristics.

In step 802, a plurality of consumer profiles (e.g., the consumer profiles 208) may be stored, in a database (e.g., the consumer database 112), wherein each consumer profile 208 includes data related to a consumer (e.g., the consumer 102), including at least a consumer identifier associated with the related consumer 102, a plurality of consumer characteristics, and a plurality of transaction data entries (e.g., transaction data entries 212), each transaction data entry 212 corresponding to a payment transaction involving the related consumer 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 804, a consumer profile request may be received, by a receiving device (e.g., the receiving unit 202), wherein the consumer profile request includes at least a specific consumer identifier. In step 806, a specific consumer profile 208 may be identified, in the consumer database 112, where the included consumer identifier corresponds to the specific consumer identifier. In step 808, a request for medical data may be transmitted, by a transmitting device (e.g., the transmitting unit 206), wherein the request for medical data includes at least the plurality of consumer characteristics included in the identified specific consumer profile 208.

In step 810, the receiving device 202 may receive medical data. In one embodiment, the request for medical data may further include a predefined number, the received medical data may be associated with demographic characteristics, and a number of the plurality of consumer characteristics included in the specific consumer profile 208 that correspond to the plurality of demographic characteristics is at least the predefined number. In a further embodiment, the plurality of demographic characteristics may not be personally identifiable. In some embodiments, the medical data may include data included in an electronic health record corresponding to the associated specific consumer 102. In one embodiment, the medical data may be obtained with the express consent of the associated specific consumer 102.

In step 812, the received medical data may be included, in the consumer database 112, in the identified specific consumer profile 208. In step 814, the specific consumer profile 208 including the received medical data may be transmitted, by the transmitting unit 206, in response to the received consumer profile request.

### Exemplary Method for Directly Linking Medical Data to Transaction History

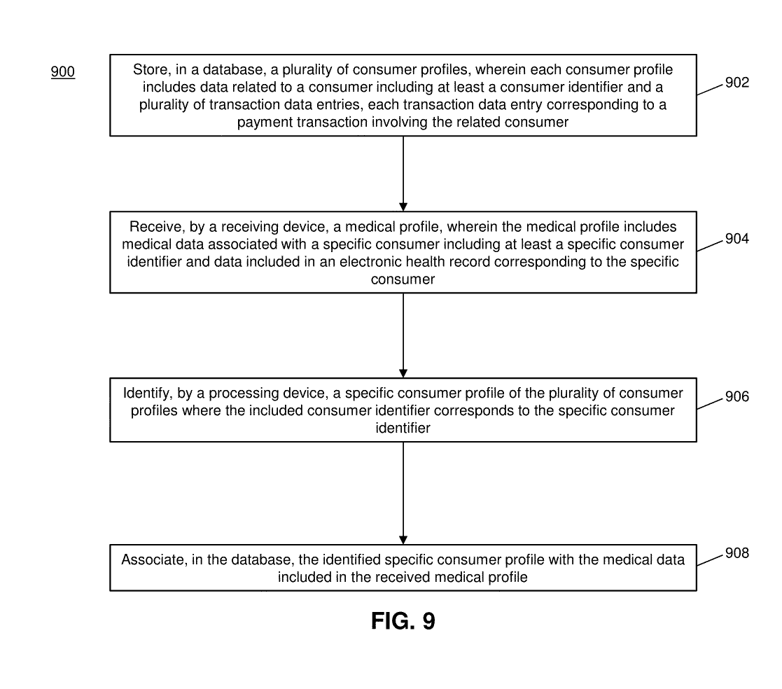

FIG. 9 illustrates a method 900 for linking consumer medical data for a specific consumer to transaction history and demographic characteristics. In an exemplary embodiment, the method 900 is performed with the express consent of the specific consumer.

In step 902, a plurality of consumer profiles (e.g., consumer profiles 208) may be stored, in a database (e.g., the consumer database 112), wherein each consumer profile 208 includes data related to a consumer (e.g., the consumer 102) including at least a consumer identifier and a plurality of transaction data entries, each transaction data entry corresponding to a payment transaction involving the related consumer 102. In one embodiment, each transaction data entry may include at least transaction data, a consumer identifier associated with the related consumer 102, and a merchant identifier associated with a merchant (e.g., the merchant 104) involved in the corresponding payment transaction.

In step 904, a medical profile may be received, by a receiving device (e.g., the receiving unit 202), wherein the medical profile includes medical data associated with a specific consumer 102 including at least a specific consumer identifier and data included in an electronic health record corresponding to the specific consumer 102. In some embodiments, the medical data may include no personally identifiable information. In an exemplary embodiment, the medical profile may be obtained with the express consent of the associated specific consumer 102.

In step 906, a specific consumer profile 208 of the plurality of consumer profiles may be identified, by a processing device (e.g., the processing unit 204), where the included consumer identifier corresponds to the specific consumer identifier. In step 908, the identified specific consumer profile 208 may be associated, in the consumer database 112, with the medical data included in the received medical profile.

### Computer System Architecture

FIG. 10 illustrates a computer system 1000 in which embodiments of the present disclosure, or portions thereof, may be implemented as computer-readable code. For example, the processing server 108 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6A, 6B, and 7-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3, 4, 6A, 6B, and 7-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for linking medical data to transaction history and distributing linked consumer profiles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking medical data to transaction history, comprising:
storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer;
receiving, by a receiving device, a medical profile, wherein the medical profile includes medical data associated with a specific consumer and a plurality of demographic characteristics associated with the specific consumer;
identifying, by a processing device, at least one consumer profile of the plurality of consumer profiles where at least a predefined number of the included plurality of consumer characteristics correspond to the plurality of demographic characteristics; and
associating, in the database, each of the identified at least one consumer profile with the medical data included in the received medical profile.

2. The method of claim 1, wherein the plurality of consumer characteristics includes at least one of: age, gender, income, marital status, familial status, residential status, occupation, education, zip code, postal code, street address, county, city, state, and country.

3. The method of claim 1, wherein each transaction data entry includes at least transaction data, a consumer identifier associated with the related consumer, and a merchant identifier associated with a merchant involved in the corresponding payment transaction.

4. The method of claim 1, wherein the plurality of consumer characteristics are not personally identifiable.

5. The method of claim 1, wherein the medical data includes data included in an electronic health record corresponding to the associated specific consumer.

6. The method of claim 1, wherein the plurality of demographic characteristics are not personally identifiable.

7. The method of claim 1, wherein the medical data includes no personally identifiable information.

8. The method of claim 1, wherein the medical profile is obtained with the express consent of the associated specific consumer.

9. A method for distributing a linked consumer profile, comprising:
storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
receiving, by a receiving device, a consumer profile request, wherein the consumer profile request includes at least a specific consumer identifier;
identifying, in the database, a specific consumer profile where the included consumer identifier corresponds to the specific consumer identifier;
transmitting, by a transmitting device, a request for medical data, wherein the request for medical data includes at least a predefined number of the plurality of consumer characteristics included in the identified specific consumer profile;
receiving, by the receiving device, medical data;
including, in the database, the received medical data in the identified specific consumer profile; and
transmitting, by the transmitting device, the specific consumer profile including the received medical data in response to the received consumer profile request.

10. The method of claim 9, wherein the medical data is associated with a plurality of demographic characteristics, and at least the predefined number of the plurality of consumer characteristics included in the specific consumer profile correspond to the plurality of demographic characteristics.

11. The method of claim 9, wherein the plurality of consumer characteristics includes at least one of: age, gender, income, marital status, familial status, residential status, occupation, education, zip code, postal code, street address, county, city, state, and country.

12. The method of claim 9, wherein each transaction data entry includes at least transaction data, a consumer identifier associated with the related consumer, and a merchant identifier associated with a merchant involved in the corresponding payment transaction.

13. The method of claim 9, wherein the plurality of consumer characteristics are not personally identifiable.

14. The method of claim 9, wherein the medical data includes data included in an electronic health record corresponding to the associated specific consumer.

15. The method of claim 9, wherein the plurality of demographic characteristics are not personally identifiable.

16. The method of claim 9, wherein the medical data includes no personally identifiable information.

17. The method of claim 9, wherein the medical data is obtained with the express consent of the associated specific consumer.

18. A method for linking medical data to transaction history, comprising:
storing, in a database, a plurality of consumer profiles, wherein each consumer profile includes data related to a consumer including at least a consumer identifier and a plurality of transaction data entries, each transaction data entry corresponding to a payment transaction involving the related consumer;
receiving, by a receiving device, a medical profile, wherein the medical profile includes medical data associated with a specific consumer including at least a specific consumer identifier and data included in an electronic health record corresponding to the specific consumer;
identifying, by a processing device, a specific consumer profile of the plurality of consumer profiles where the included consumer identifier corresponds to the specific consumer identifier; and
associating, in the database, the identified specific consumer profile with the medical data included in the received medical profile.

19. The method of claim 18, wherein each transaction data entry includes at least transaction data, a consumer identifier associated with the related consumer, and a merchant identifier associated with a merchant involved in the corresponding payment transaction.

20. The method of claim 18, wherein the medical data includes no personally identifiable information.

21. The method of claim 18, wherein the medical profile is obtained with the express consent of the associated specific consumer.

22. A system for linking medical data to transaction history, comprising:
a database configured to store a plurality of consumer profiles, wherein each consumer profile includes data related to a consumer including at least a plurality of consumer characteristics and a plurality of transaction data entries, each transaction data entry corresponding to a payment transaction involving the related consumer;
a receiving device configured to receive a medical profile, wherein the medical profile includes medical data associated with a specific consumer and a plurality of demographic characteristics associated with the specific consumer; and
a processing device configured to
identify at least one consumer profile of the plurality of consumer profiles where at least a predefined number of the included plurality of consumer characteristics correspond to the plurality of demographic characteristics, and
associate, in the database, each of the identified at least one consumer profile with the medical data included in the received medical profile.

23. The system of claim 22, wherein the plurality of consumer characteristics includes at least one of: age, gender, income, marital status, familial status, residential status, occupation, education, zip code, postal code, street address, county, city, state, and country.

24. The system of claim 22, wherein each transaction data entry includes at least transaction data, a consumer identifier associated with the related consumer, and a merchant identifier associated with a merchant involved in the corresponding payment transaction.

25. The system of claim 22, wherein the plurality of consumer characteristics are not personally identifiable.

26. The system of claim 22, wherein the medical data includes data included in an electronic health record corresponding to the associated specific consumer.

27. The system of claim 22, wherein the plurality of demographic characteristics are not personally identifiable.

28. The system of claim 22, wherein the medical data includes no personally identifiable information.

29. The system of claim 22, wherein the medical profile is obtained with the express consent of the associated specific consumer.

30. A system for distributing a linked consumer profile, comprising:
a database configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
a receiving device configured to receive a consumer profile request, wherein the consumer profile request includes at least a specific consumer identifier;
a processing device configured to identify, in the database, a specific consumer profile where the included consumer identifier corresponds to the specific consumer identifier; and
a transmitting device configured to transmit a request for medical data, wherein the request for medical data includes at least a predefined number of the plurality of consumer characteristics included in the identified specific consumer profile, wherein
the receiving device is further configured to receive medical data,
the processing device is further configured to include, in the database, the received medical data in the identified specific consumer profile, and
the transmitting device is further configured to transmit the specific consumer profile including the received medical data in response to the received consumer profile request.

31. The system of claim 30, wherein the medical data is associated with a plurality of demographic characteristics, and at least the predefined number of the plurality of consumer characteristics included in the specific consumer profile correspond to the plurality of demographic characteristics.

32. The system of claim 30, wherein the plurality of consumer characteristics includes at least one of: age, gender, income, marital status, familial status, residential status, occupation, education, zip code, postal code, street address, county, city, state, and country.

33. The system of claim 30, wherein each transaction data entry includes at least transaction data, a consumer identifier associated with the related consumer, and a merchant identifier associated with a merchant involved in the corresponding payment transaction.

34. The system of claim 30, wherein the plurality of consumer characteristics are not personally identifiable.

35. The system of claim 30, wherein the medical data includes data included in an electronic health record corresponding to the associated specific consumer.

36. The system of claim 30, wherein the plurality of demographic characteristics are not personally identifiable.

37. The system of claim 30, wherein the medical data includes no personally identifiable information.

38. The system of claim 30, wherein the medical data is obtained with the express consent of the associated specific consumer.

39. A system for linking medical data to transaction history, comprising:
a database configured to store a plurality of consumer profiles, wherein each consumer profile includes data related to a consumer including at least a consumer identifier and a plurality of transaction data entries, each transaction data entry corresponding to a payment transaction involving the related consumer;
a receiving device configured to receive a medical profile, wherein the medical profile includes medical data associated with a specific consumer including at least a specific consumer identifier and data included in an electronic health record corresponding to the specific consumer; and
a processing device configured to
identify a specific consumer profile of the plurality of consumer profiles where the included consumer identifier corresponds to the specific consumer identifier, and
associate, in the database, the identified specific consumer profile with the medical data included in the received medical profile.

40. The system of claim 39, wherein each transaction data entry includes at least transaction data, a consumer identifier associated with the related consumer, and a merchant identifier associated with a merchant involved in the corresponding payment transaction.

41. The system of claim 39, wherein the medical data includes no personally identifiable information.

42. The system of claim 39, wherein the medical profile is obtained with the express consent of the associated specific consumer.
